(19) United States
(12) Patent Application Publication
(10) Pub. No.: US 2023/0181950 A1
(43) Pub. Date: Jun. 15, 2023

(54) BATTERY ARRANGEMENT AND METHOD FOR FIGHTING A BATTERY FIRE AND MOTOR VEHICLE

(71) Applicant: AUDI AG, Ingoistadt (DE)

(72) Inventors: Dirk BÄDER, Fellbach (DE); Michael GRABOWSKI, Ingolstadt (DE)

(73) Assignee: AUDI AG, Ingolstadt (DE)

(21) Appl. No.: 18/078,374

(22) Filed: Dec. 9, 2022

(30) Foreign Application Priority Data
Dec. 9, 2021 (DE) 102021132499.8

(51) Int. Cl. A62C 3/16; A62C 37/40; H02J 7/00; H01M 50/383

(52) U.S. Cl. CPC A62C 3/16; A62C 37/40; H02J 7/0047; H02J 7/0045; H01M 50/383

(57) ABSTRACT

A battery arrangement for a motor vehicle for fighting a battery fire. The battery arrangement includes a battery having at least one battery cell, which is arranged in a battery housing. A charging device is designed to provide electrical energy to the at least one battery cell when connected to a motor vehicle-external energy supply system. Furthermore, a detection device is formed for detecting a predetermined heating state of the battery, which indicates that a battery fire is present or at least imminent. The charging device also includes an extinguishing agent supply unit for fighting fires. The extinguishing agent supply unit is designed, when connected to a motor vehicle-external extinguishing agent reservoir and when the predetermined heating state is present, to provide a predetermined extinguishing agent for supply into the battery housing.

### FIELD

The invention relates to a battery arrangement for a motor vehicle for fighting a battery fire. The battery arrangement comprises a battery having at least one battery cell, which is arranged in a battery housing. Furthermore, the battery arrangement comprises a charging device which is designed to provide electrical energy to the at least one battery cell when connected to a motor vehicle-external energy supply system. In addition, the battery arrangement comprises a detection device for detecting a predetermined heating state of the battery, which indicates that a battery fire is present or at least imminent. The invention also relates to a motor vehicle having a corresponding battery arrangement and a method for fighting a battery fire.

### BACKGROUND

A battery can be used in a motor vehicle for different functions or purposes. For example, a battery can be used as a starter battery or low-voltage battery (<30 volts DC nominal voltage) for a motor vehicle. Furthermore, a battery can be used as a drive battery or high-voltage battery (>30 volts DC nominal voltage) for supplying a vehicle electrical system and/or to electrically operate an electric drive of the motor vehicle. Motor vehicles having a corresponding drive battery are known as battery-electric vehicles or electric vehicles or hybrid vehicles.

To provide the desired electrical power or energy, the battery uses at least one, that is, one or more battery cells. If required, multiple battery cells can be electrically connected to one another in a suitable manner. In the present case, “battery cell” means a galvanic cell, i.e., an electrochemical energy storage device. Various technologies are known for the electrochemistry of a battery cell, thus an active material that is used for electrochemical energy conversion. For example, there are battery cells that are based on lithium-ion technology or lithium-iron phosphate technology.

A rechargeable battery or a secondary battery is generally installed as the battery in a motor vehicle. That is to say the battery or its battery cell(s) is rechargeable. Electrochemical reactions of the active material can thus be reversible. For (re)charging, the battery can be connected to an external energy supply system by means of a charging device. Electrical energy can be provided or transferred via the charging device from the energy supply system for charging to the respective battery cell of the battery.

If the battery is operated as intended, thus, for example, when charging or discharging or in the idle state, a fire of the battery can occur under certain conditions. Such a condition can exist, for example, if the battery has a defect and/or there is a short circuit and/or the electrochemistry of a battery cell is damaged. For example, a detection device can be used to detect a battery fire or at least an impending fire. This device can check whether a predetermined heating state exists for the battery, which is associated with the presence or imminence of a battery fire.

For the case that a fire breaks out, the requirement can be made that no flames may appear outside the battery, i.e., a battery housing, for a certain period of time, thus, for example, up to five minutes after the fire breaks out. This means that the battery fire is to be fought or at least contained until, for example, an extinguishing procedure can be implemented by the fire department. Damage to people or surrounding vehicles or infrastructure can thus be avoided. Various options are known from the prior art for fighting a battery fire.

CN 11 204 395 A discloses a fire extinguishing mechanism for detecting and extinguishing lithium-ion batteries. A fire extinguisher is used for this purpose, which in case of fire can provide an extinguishing agent to each individual battery cell of a drive battery via a respective supply line.

WO 2020/214850 A1 discloses a method for cooling a battery cell. A cooling liquid is atomized using a micro-nozzle, so that liquid aerosol particles result. These are provided to the battery cell.

JP 2014-090782 A discloses a battery module that comprises a plurality of sodium-sulfur battery cells in a housing. A fire extinguisher is connected to the housing via a supply line. If a fire is detected in the housing, a solid extinguishing agent is burned in an extinguishing body of the fire extinguisher, so that aerosol results. The aerosol is provided to the battery cells in the housing via the supply line.

In the prior art, an internal device of a battery or a motor vehicle is thus used to fight the battery fire. As a result, only a limited volume of extinguishing agent is available for firefighting in order to save space and weight in the motor vehicle. Therefore, the extinguishing capacity and/or fighting duration of the extinguishing agent is limited.

### SUMMARY

It is the object of the present invention to provide an effective option for fighting battery fires of a battery arrangement.

In order to implement effective firefighting, the charging device of the battery arrangement mentioned at the outset is supplemented by an extinguishing agent supply unit. The extinguishing agent supply unit is designed, when connected to a motor vehicle-external extinguishing agent reservoir and when the predetermined heating state is present, to provide a predetermined extinguishing agent for supply into the battery housing. This means that both the electrical energy for supplying the respective battery cell and the extinguishing agent can be made available and transferred by means of the charging device when the predetermined heating state is present. In this way, a combined supply of extinguishing agent can be implemented in the charging device for direct extinguishing in case of a battery fire.

The combination of the extinguishing supply with the charging device results in the advantage that a user of the motor vehicle is reminded, for example when charging the vehicle, to couple the vehicle-external extinguishing agent reservoir. It can thus be ensured that the extinguishing agent reservoir can be accessed directly in case of a battery fire. The fact that a motor vehicle-external system is used to provide the extinguishing agent rather than a vehicle-internal system additionally results in the advantage that there is essentially no need to limit the volume of extinguishing agent to save space or weight in the motor vehicle. As a result, an arbitrarily large extinguishing capacity is available for firefighting. This makes it particularly easy to avoid personal injury caused by fire, for example. In addition, the burning motor vehicle can be prevented from damaging adjacent vehicles or infrastructure or buildings. Fast and effective firefighting can be made possible in this way, especially in areas that are difficult for the fire department to access, such as an underground parking garage, a transport ship, a train, or an aircraft. A vehicle owner of the corresponding motor vehicle also does not need to worry about high insurance ratings due to the potential risk of a battery fire.

For the electrical energy supply of the respective battery cells, the charging device can comprise, for example, a charging connection and an electrical line element, for example a line cable. The line element can, for example, be laid or installed between the respective battery cell and the charging connection. The charging device for the electrical energy supply can preferably be made bidirectional. The battery can thus be both charged and discharged by means of the charging device. In order to control the respective charging and/or discharging process, the charging device can have charging electronics, for example. The charging electronics can be implemented, for example, in a battery management system or a central on-board computer of the motor vehicle. To provide the electrical energy, the motor vehicle-external energy supply system can be designed, for example, as a charging infrastructure or as a charging station or as a home power connection, for example a so-called wall box.

In order to supply the extinguishing agent into the battery housing, the extinguishing agent supply unit can have, for example, an extinguishing agent supply connection and a fluidic line element, for example a pipe or a hose. The line element can be laid or installed for fluidic connection between the battery housing and the charging connection. For example, water or any predetermined extinguishing agent suitable for extinguishing a battery fire can be used as the extinguishing agent. The extinguishing agent reservoir for providing the extinguishing agent can be provided, for example, by means of a house water connection or a city water connection. Additionally or alternatively, the extinguishing agent reservoir can be designed as a water tank, for example. Thus, the extinguishing agent reservoir can be provided, for example, by a motor vehicle-external building infrastructure or means of transport infrastructure.

The predetermined heating state can occur, for example, in the event of a thermal runaway of the respective battery cell. Thermal runaway, also known as thermal propagation, describes a state in which the active material of the battery cell undergoes an unstoppable, exothermic chemical reaction under certain conditions. Depending on the technology, the battery cell releases a large part of its stored electrochemical energy in the form of thermal energy within a very short time. Thermal runaway occurs, for example, when the battery cell overheats. That is to say when the battery cell exceeds a predetermined temperature limiting value. In the case of a battery cell based on lithium-ion technology, for example, the reaction temperature is approximately 85 degrees Celsius. The lithium-ion battery cell can release up to 60 percent of the stored energy within approximately one millisecond.

The invention also includes embodiments which result in additional advantages.

According to one embodiment, the charging device for coupling to the motor vehicle-external energy supply system comprises a charging connection. In addition, the extinguishing agent supply unit includes an extinguishing agent supply connection for coupling to the motor vehicle-external extinguishing agent reservoir. The charging connection and the extinguishing agent supply connection are formed here in a common connection element of the charging device.

In the present case, a charging connection means an electrical connection. For example, the charging connection can be formed as a plug or a socket. In the present case, an extinguishing agent supply connection means a fluid connection, such as a water connection. The connection or coupling to the energy supply system or the extinguishing agent reservoir can take place, for example, by means of a plug connection or catch connection or a predetermined reversible or detachable connection method.

This means that a charging plug, as is known, for example, for charging electric vehicles, can be supplemented with a further connection space. The further connection space is occupied by the water connection. A combined water connection can thus be provided in a charging plug for direct extinguishing in case of a battery fire. This results in the advantage that the user only needs to implement one connection process both for charging and for fire prevention or firefighting when parking his vehicle. As a result, effective firefighting can be ensured in a particularly simple manner for the battery arrangement.

According to a further embodiment, the charging device has a closure element having a locking mechanism for allowing and/or preventing access to the charging device. The closure element is thus lockable and/or unlockable using the locking mechanism. The closure element covers the charging device from external access. This means that the above-mentioned charging connection and the extinguishing agent supply connection can be concealed or covered by the closure element, for example. For this purpose, for example, a supply area can be provided in which the charging device is arranged. The supply area can be covered by means of the closure element and thus shielded. The closure element can accordingly be a charging flap or tank flap or maintenance flap or extinguishing flap, for example. In the supply area, the charging connection and the extinguishing agent supply connection can be formed as separate connection elements, for example. Alternatively, the charging connection and the extinguishing agent supply connection can be implemented as a common connection element, for example, as described above.

The locking mechanism can be designed to be mechanically and/or electronically actuatable. In addition, the locking mechanism can be implemented as active or passive. Passive means that the locking mechanism can be locked or unlocked, for example, without an additional unlocking unit. The closure element can be designed, for example, as a pressure-actuated charging flap. An active locking mechanism can be understood, for example, as a mechanism that requires an additional unlocking unit in order to be locked or unlocked. The unlocking unit can be, for example, a specific key or a specific control signal or manual actuation after removing a protective cap, for example.

In a further embodiment, the extinguishing agent supply unit comprises a valve element which is designed to adjust a mass flow of the extinguishing agent provided in dependence on the detection of the predetermined heating state. This means that the valve element can be adjustable between at least two positions. In an open position, the selected extinguishing agent can be introduced into the housing via the extinguishing agent supply connection. This means that a mass flow of the extinguishing agent is allowed. In a closed position, in contrast, the penetration or supply of the extinguishing agent into the housing can be prevented. The mass flow is thus blocked. The valve element can be designed to be electrically or electronically controllable, for example. This means that an actuator of the valve element can be activated by means of a control signal, for example from the detection device. In this case, the valve member can be put into the open position when the presence of the heating state is confirmed and the valve element remains or is put into the closed position when the heating state is absent.

According to a further embodiment, the detection device for detecting the predetermined heating state comprises at least one temperature sensor in a first variant. The temperature of the battery or of the respective battery cell can thus be monitored by means of the detection device. If a measured temperature value exceeds a predetermined temperature limiting value, which indicates a battery fire, the heating state can be confirmed to be present.

According to a further variant of the embodiment, the detection device for detecting the predetermined heating state comprises a pressure sensor. This means that a pressure in the battery or in the respective battery cell can be monitored. If a battery fire occurs or begins, gases can be produced due to the chemical reactions of the respective battery cell. The gases can increase the pressure in the battery cell or the battery housing. If the pressure of the battery of the battery cell thus exceeds a predetermined pressure limiting value, the heating state can be confirmed to be present.

According to a further variant of the embodiment, the detection device for detecting the predetermined heating state has a gas sensor. By means of the gas sensor, the gases produced can be detected or measured when a battery fire is present or imminent. It can thus be determined by means of the gas sensor, for example, whether the respective battery cell is outgassing. If a measured gas concentration exceeds a predetermined limiting value, the heating state can be confirmed to be present.

According to a further variant of the embodiment, the detection device for detecting the predetermined heating state comprises a fracture sensor. By means of the fracture sensor, for example, it can be determined whether the battery housing or a housing of the respective battery cell has a crack or a defect. This can be caused, for example, by mechanical influences, for example, an impact or an accident. Alternatively, the defect can also arise, for example, due to the increased pressure or the increased temperature in the event of a fire inside the battery cell or in the battery housing. Thus, once a fracture or defect is established in the battery housing or cell housing, the presence of the heating state can be confirmed.

In order to evaluate the sensor data of the respective sensor, the detection device can comprise a control device, for example. The control device can be provided, for example, by the above-mentioned battery management system or the central on-board computer of the motor vehicle. A separate sensor can be assigned, for example, to each battery cell of the battery to detect the heating state. Additionally or alternatively, a corresponding sensor can be provided for multiple battery cells, for example. In this case, multiple battery cells can be combined or connected to form a so-called battery module, for example.

According to a further embodiment, the battery housing has an extinguishing agent outlet element for discharging the extinguishing agent from the battery housing. It can thus be ensured that fresh extinguishing agent from the extinguishing agent reservoir flows continuously or steadily through the battery housing. Therefore, the thermal energy of the runaway battery cell can be dissipated more effectively and the battery fire can be successfully fought. The extinguishing agent outlet element can be integrated into the battery housing as a valve element, for example a pressure compensation valve or pressure relief valve. This means that the extinguishing agent outlet element can be adjusted automatically between the above-mentioned open and closed position depending on the pressure that the extinguishing agent exerts on a valve body of the valve element. Therefore, the mass flow out of the battery housing can be adjusted.

According to a further embodiment, the charging device comprises an extinguishing agent discharge unit. The extinguishing agent discharge unit is designed to discharge the supplied extinguishing agent from the battery housing to a motor vehicle-external waste water reservoir in a closed state to provide it to the waste water reservoir. An extinguishing agent circuit through the battery can thus be implemented by means of the charging device. Fresh or unused extinguishing agent is introduced from the extinguishing agent reservoir into the battery housing and the contaminated extinguishing agent is discharged from the battery housing to the waste water reservoir. It can thus be ensured that the contaminated extinguishing agent, i.e., the extinguishing agent used for firefighting, is not released into the surroundings or the environment. Rather, the contaminated extinguishing agent can be temporarily stored in the waste water reservoir. By means of a purification method, the temporarily stored extinguishing agent can then be purified, for example, of pollutants such as particles or substances from the electrochemistry of the battery cell.

The waste water reservoir can be formed, for example, as an additional tank or temporary store for the extinguishing agent. Additionally or alternatively, the battery arrangement can have an extinguishing agent device, wherein the extinguishing agent reservoir and the waste water reservoir are comprised by the extinguishing agent device. For example, the extinguishing agent reservoir and the waste water reservoir can be two fluidically connected chambers of a water tank of the extinguishing agent device. In this way, an extinguishing agent circuit can be implemented and wastage of extinguishing agent can be avoided. For filtering or purifying or treating the contaminated extinguishing agent, the extinguishing agent device can comprise a purifying device which is arranged between the extinguishing agent reservoir and the waste water reservoir. Additionally or alternatively, the extinguishing agent device can comprise a cooling device which is designed to cool the extinguishing agent of the waste water reservoir to a predetermined temperature. A cooling circuit can thus be implemented in which the extinguishing agent can be reused.

To discharge the extinguishing agent, the extinguishing agent discharge unit can have, for example, an extinguishing agent discharge connection and an additional fluidic line element that fluidly connects the battery housing and the extinguishing agent discharge connection to one another. The extinguishing agent discharge connection can, for example, be formed with the charging connection and the extinguishing agent supply connection in the common connection element of the charging device. Alternatively, the extinguishing agent discharge connection can be implemented as a separate connection in the above-mentioned supply area.

The invention also relates to a method for fighting a battery fire of a battery arrangement for a motor vehicle, as has been described above. The battery arrangement comprises a battery having at least one battery cell, which is arranged in a battery housing. In order to provide electrical energy to the at least one battery, a charging device of the battery arrangement is connected to a motor vehicle-external energy supply system. It is checked by means of a detection device of the battery arrangement whether the drive battery is in a predetermined heating state, which indicates that a battery fire has occurred. The charging device also comprises an additional extinguishing agent supply unit. The extinguishing agent supply unit is connected to a motor vehicle-external extinguishing agent reservoir, and a predetermined extinguishing agent is provided for supply into the battery housing by means of the extinguishing agent supply unit.

The invention also relates to a motor vehicle having a battery arrangement as described above. The motor vehicle is designed, for example, as an electric vehicle or as a hybrid vehicle (plug-in hybrid). The motor vehicle can preferably be designed as an automobile, in particular a passenger car or a truck, or as a passenger bus or a motorcycle.

In one embodiment of the motor vehicle, the above-described closure element of the battery arrangement is designed as a charging connection flap of the motor vehicle, by means of which (at least) the charging connection of the charging unit and the extinguishing agent supply connection of the extinguishing agent supply unit can be covered from the outside.

Of course, the invention can also relate to a system made up of a motor vehicle having the battery arrangement and a motor vehicle-external energy supply system and the motor vehicle-external extinguishing agent reservoir, as described above. The energy supply system can, for example, comprise a corresponding connection element to the charging connection. Analogously, the extinguishing agent reservoir can comprise, for example, a corresponding connection element to the extinguishing agent supply connection and, for example, also to the extinguishing agent discharge connection.

The invention also includes refinements of the method according to the invention and the motor vehicle according to the invention, which have features as already described in the context of the refinements of the battery arrangement according to the invention. For this reason, the corresponding refinements of the method according to the invention and the motor vehicle according to the invention are not described again here.

The invention also comprises the combinations of the features of the described embodiments. The invention also comprises implementations that each have a combination of the features of several of the described embodiments, unless the embodiments were described as mutually exclusive.

### BRIEF DESCRIPTION OF THE FIGURES

Exemplary embodiments of the invention are described hereinafter. In the figures:

FIG. 1 shows a schematic representation of a motor vehicle having a battery arrangement for fighting a battery fire;

FIG. 2 shows a schematic representation of a charging device of the battery arrangement according to a first exemplary embodiment; and

FIG. 3 shows a schematic representation of a charging device of the battery arrangement according to a second exemplary embodiment.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another and are thus also to be considered to be part of the invention individually or in a combination other than that shown. Therefore, the disclosure is also intended to comprise combinations of the features of the embodiments other than those represented. Furthermore, the described embodiments can also be supplemented by further ones of the already described features of the invention.

In the figures, the same reference numerals respectively designate elements that have the same function.

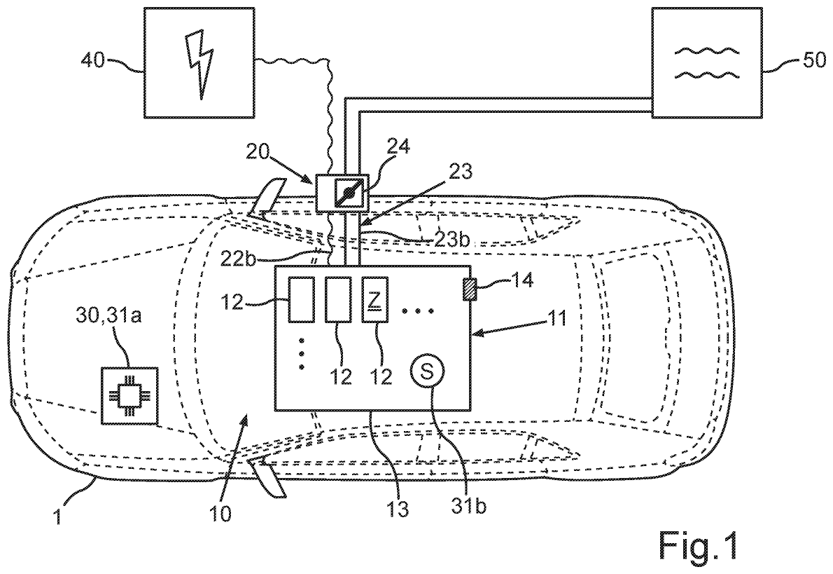

FIG. 1 shows a motor vehicle from a bird's eye perspective in a schematic sectional view. The motor vehicle 1 has a battery arrangement 10 which is designed to fight a battery fire. The battery arrangement 10 comprises a battery 11 having at least one battery cell 12, which is arranged in a battery housing 13. In FIG. 1, the battery 11 is embodied, for example, as a drive battery or high-voltage battery (HV storage device) for operating an electric drive of the motor vehicle 1. The motor vehicle can thus be an electric vehicle or a hybrid vehicle. The battery 11 in the present example comprises three battery cells 12. Of course, more or fewer such battery cells can also be provided to form the battery 11.

To form the battery 11, the battery cells 12 can, for example, be electrically connected to one another in a suitable manner (not shown in FIG. 1). The battery cells 12 are so-called electrochemical or galvanic cells. In the present case, the battery cells 12 are lithium-ion cells, for example. The battery cells 12 are designed as accumulator cells or secondary batteries. That is, the battery cells 12 can be both charged and discharged.

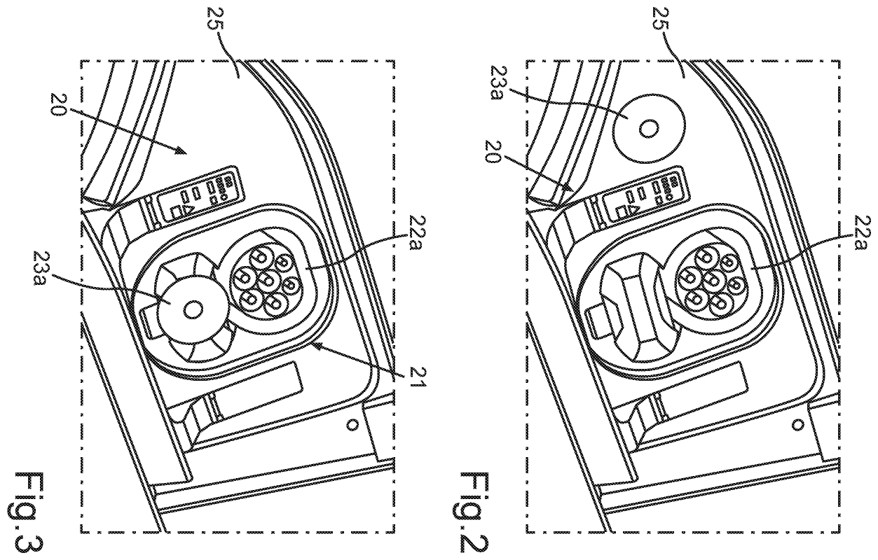

In order to be able to charge the battery 11, i.e., the battery cells 12 for the electrical energy supply, i.e., to be able to supply it with electrical energy, the battery arrangement 10 according to FIG. 1 comprises a charging device 20. The charging device 20 is designed to be coupled to a motor vehicle-external energy supply system 40. The motor vehicle-external energy supply system 40 can be, for example, a charging infrastructure or charging station or, for example, a home power connection. In the coupled or connected state, electrical energy can be provided or transferred to the battery cells 12 of the battery 11 by the motor vehicle-external energy supply system. In order to be able to couple the energy supply system 40 to the battery arrangement, the charging device 20 comprises, for example, a charging connection 22a (not shown in FIG. 1) (see FIGS. 2 and 3) and an electrical line element 22b. The line element 22b can be connected or installed for electrical contacting or connection between the respective battery cell 12 and the charging connection 22a.

Overheating can occur under certain conditions, for example if one of the respective battery cells 12 is defective. The overheating can occur both in the charging or discharging mode of the battery 11, but also in the idle state of the battery 11. In the present case, overheating means that the respective battery cell 12 thermally runs away. That is, the temperature of the battery cell 12 reaches or exceeds a predetermined temperature limiting value, so that the battery cell 12 undergoes an unstoppable and exothermic chemical reaction. A large part of the electrochemical energy stored in the battery cell can be released in the form of thermal energy. The release of thermal energy can cause a battery fire. The temperature limiting value and the amount of energy released as well as the reaction speed depend, for example, on a technology of the respective battery cell 12. With a lithium-ion battery cell, for example, the temperature limiting value is approximately 80 to 85 degrees Celsius. If the temperature of a lithium-ion cell exceeds this limiting value, it releases approximately 60 percent of the stored electrical energy in the form of thermal energy within a few milliseconds.

In order to be able to detect or establish the presence or at least the imminence of a battery fire, the battery arrangement 10 in the present case comprises a detection device 30. The detection device 30 is designed to determine a predetermined heating state Z of the battery 11 or its battery cells 12. In the present case, heating state Z means, for example, exceeding the specified temperature limiting value, i.e., the presence of thermal runaway. For this purpose, the detection device 30 comprises a control unit 31a and a sensor unit 31b. According to FIG. 1, the sensor unit 31b is arranged in the battery housing 13 of the battery 11. Here, the sensor unit 31b can comprise, for example, one or more temperature sensors to monitor the temperature of the battery cells 12. The temperature data or sensor data acquired by means of the temperature sensor can be evaluated by means of the control unit 31a. The control unit 31a can thus check, for example, whether the temperature of the respective battery cell 12 according to the temperature data exceeds the predetermined temperature limiting value, which allows conclusions to be drawn about the presence of the heating state Z. The control unit 31a of the detection device 30 can be provided by a central on-board computer of the motor vehicle 1 or a battery management system of the battery 11, for example.

In order to be able to fight the battery fire, for example, to be able to extinguish it, when it is determined that the heating state Z is present, the detection device can, for example, send an emergency call signal to alert the fire department. For this purpose, the detection device 30 can have a corresponding communication unit, for example a radio module, such as a mobile radio module.

In order to avoid personal injury and/or property damage in case of fire, the battery arrangement, as shown in FIG. 1, can provide another firefighting measure. For this purpose, the charging device 20 according to FIG. 1 additionally comprises an extinguishing agent supply unit 23. The extinguishing agent supply unit is designed to be coupled to a motor vehicle-external extinguishing agent reservoir 50. A desired extinguishing agent that is suitable for extinguishing the battery fire can be temporarily stored or made available in the extinguishing agent reservoir. Water, for example, can be used as an extinguishing agent. The extinguishing agent reservoir 50 is shown here, for example, as a water tank. Alternatively, the extinguishing agent reservoir 50 can also be implemented as a house water connection or city water connection, for example. In the connected or coupled state of the extinguishing agent supply unit 23 with the extinguishing agent reservoir 50, a predetermined extinguishing agent can be made available or provided by the extinguishing agent reservoir 50. As soon as the detection device 30 additionally confirms the presence of the heating state Z for the battery 11 or at least one of the battery cells 12, the extinguishing agent can be introduced or supplied into the battery housing 13 via the extinguishing agent supply unit.

For the fluidic connection of the extinguishing agent supply unit 23 to the battery housing 13, the extinguishing agent supply unit 23 comprises an extinguishing agent supply connection 23a (not shown in FIG. 1) and a fluidic line element 23b. As shown in FIG. 1, the fluidic line element 23b is installed for the fluidic connection between the battery housing 13 and the extinguishing agent supply connection 23a.

In order to provide the extinguishing agent only when required, i.e., only when the heating state Z is present, the extinguishing agent supply unit 23 comprises a valve element 24, for example in the area of the extinguishing agent supply connection 23a. A mass flow of the provided extinguishing agent can be adjusted by means of the valve element 24 in dependence on the detection of the heating state Z. In this case, for example, a control signal can be provided by the detection device 30 to an actuator of the valve element 24 when the heating state Z is detected. The valve element can be put into an open position by the control signal, so that the extinguishing agent reservoir 50 and the battery housing are fluidically connected to one another. The extinguishing agent can thus flow into the battery housing 13. Otherwise, the valve element 24 is in a closed position, in which a pressure of the extinguishing agent is applied to a valve body of the valve element 24, but the valve element blocks the mass flow.

The valve element 24 can additionally be secured or protected against vandalism or misuse from the outside. This means that the valve element only opens, for example, when the control signal from the detection device 30 confirms the presence of the heating state Z. Mechanical opening, on the other hand, is not possible. Alternatively, a mechanical opening or unlocking of the valve element can be possible, for example, using a predetermined unlocking unit. Thus, the fire department can use the extinguishing agent supply unit 23a, for example, to supply an extinguishing agent. For example, a predetermined key or a corresponding unlocking code, which is provided in the detection device 30, can be provided here as the unlocking unit.

To improve the extinguishing effect, the battery housing 13 has, as shown in FIG. 1, an extinguishing agent outlet element 14 for discharging the extinguishing agent introduced into the battery housing 13. The extinguishing agent outlet element 14 can be designed, for example, as a pressure compensation valve. This means that the extinguishing agent outlet element can be adjusted automatically between the open and the closed position in dependence on a pressure which acts on a valve body. A steady flow of extinguishing agent in the battery housing 13 can thus be ensured and improved cooling or firefighting can be implemented as a result.

Additionally or alternatively to the extinguishing agent outlet element 14, the charging device 20 can be supplemented by an extinguishing agent discharge unit (not shown in FIG. 1) in order to provide a steady extinguishing agent flow. This can be implemented analogously to the extinguishing agent supply unit 23, wherein the extinguishing agent discharge unit is designed to be coupled to a motor vehicle-external waste water reservoir. The supplied extinguishing agent can be discharged from the battery housing 13 to the waste water reservoir by means of the extinguishing agent discharge unit. Therefore, the contaminated extinguishing agent, i.e., the extinguishing agent that was exposed to electrochemistry of the battery cells 12, does not need to be released to the surroundings or to the environment. Instead, it can be temporarily stored in the waste water reservoir, such as a tank, until treatment or purification.

FIGS. 2 and 3 now show exemplary design options of how the charging device 20 can be implemented or embodied in the motor vehicle 1. This relates in particular to how the charging connection 22a and the extinguishing agent supply connection 23a can be designed. A common supply area 25 is provided in FIG. 2 and FIG. 3, from which the charging connection 22a and the extinguishing agent supply connection 23a are led out to an outer surface or surface of the motor vehicle 1. The supply area 25 of the charging device 20 can be provided with a locking mechanism, for example by means of a locking element, in order to permit or prevent access to the charging device. The closure element can be implemented, for example, by a charging connection flap of the motor vehicle 1 (not shown in FIGS. 2 and 3). The charging connection flap 22a and the extinguishing agent supply connection 23a can be covered from the outside by means of the charging connection flap.

According to FIGS. 2 and 3, the charging connection 22a is designed as a known electrical connection (high-voltage plug unit) for an electric or hybrid vehicle. The extinguishing agent supply connection 23a is designed accordingly as a standard water connection. To connect the motor vehicle-external energy supply system 40 or the extinguishing agent reservoir 50, a counterpart corresponding to the charging connection 22a and the extinguishing agent supply connection 23a can be provided as the respective connection element. For coupling, the respective mating connecting elements or connecting parts can be connected to one another in a known manner, for example in a plug connection or catch connection.

In FIG. 2, the extinguishing agent supply connection 23a and the charging connection 23a are designed as separate connection elements in the supply area 25. This means that two separate connecting or plugging processes are necessary in order to connect the motor vehicle-external energy supply system 40 and the motor vehicle-external extinguishing agent reservoir 50 to the battery arrangement 10.

In contrast to this, the charging connection 22a and the extinguishing agent supply connection 23a according to FIG. 3 form a common connection element. This means that the extinguishing agent supply connection 23a is combined with the connection element according to FIG. 1, which includes the charging connection 22a, in a common connection element 21. Thus, only one connecting or plugging process is necessary in order to be able to connect both the energy supply system 40 and the extinguishing agent reservoir 50 to the battery arrangement 10. As a result, the user only needs to apply one plug, as has been the case with battery-electric vehicles until now.

When the battery arrangement 10 described is used in a motor vehicle, the following procedure can be provided for fighting a battery fire. A customer can park his vehicle in a parking lot and connect the charging plug (energy supply system 40) and an external water line (extinguishing agent reservoir 50) to the charging device 20 of the battery arrangement 10. The water pressure of the water line, i.e., the extinguishing agent reservoir 50 external to the vehicle, is then applied to the electrically activatable valve element 24. If the vehicle now detects a critical temperature increase in the battery 11, the temperature information, i.e., the sensor data, can be processed in the central on-board computer. At the same time, an emergency call can be made and the fire department can, for example, view vehicle data via the Internet. For example, location information or access to a location system (GPS of the motor vehicle 1) can be transmitted or granted to the fire department. In addition, the central on-board computer, i.e., the control unit 31a, can initiate the flooding of the battery 11. This means that the inflow of the extinguishing agent into the battery housing 13 can be triggered by communication or by activation of the electrically activatable valve element 24. The valve element 24 opens and the extinguishing agent can penetrate into the battery housing 13. Motor vehicle (10) having a battery arrangement (11) according to any one of preceding claims 1 to 7.

Overall, the invention provides a combined charging plug having an integrated water connection. This results in the advantage that water pressure is applied to the water line for supply to the battery arrangement 10 at all times. This means that a battery fire can be extinguished immediately after thermal runaway has been detected. In the best case, extinguishing agents, such as water, can be introduced into the battery housing at an early stage so that a fire does not start in the first place. The time span until the arrival of the fire department can thus be bridged effectively. Overall, high property damage, for example to vehicles or buildings, can be effectively avoided. As a result, battery-electric vehicles can also in future be parked in areas that are difficult to access without fear of higher insurance ratings or such vehicles being banned.

1. A battery arrangement for a motor vehicle for fighting a battery fire, comprising
a battery having at least one battery cell which is arranged in a battery housing,
a charging device which is designed to provide electrical energy to the at least one battery cell when connected to a motor vehicle-external energy supply system, and
a detection device for detecting a predetermined heating state of the battery, which indicates that a battery fire is present or at least imminent,
wherein the charging device comprises an extinguishing agent supply unit, wherein the extinguishing agent supply unit is designed, when connected to a motor vehicle-external extinguishing agent reservoir and when the predetermined heating state is present, to provide a specified extinguishing agent for supply into the battery housing.

2. The battery arrangement according to claim 1, wherein the charging device for coupling to the motor vehicle-external energy supply system comprises a charging connection and the extinguishing agent supply unit for coupling to the motor vehicle-external extinguishing agent reservoir comprises an extinguishing agent supply connection, wherein the charging connection and the extinguishing agent supply connection form a common connection element of the charging device.

3. The battery assembly according to claim 1, wherein the charging device comprises a locking element having a locking mechanism for allowing and/or preventing access to the charging device.

4. The battery arrangement according to claim 1, wherein the extinguishing agent supply unit comprises a valve element which is designed to adjust a mass flow of the extinguishing agent provided depending on the detection of the predetermined heating state.

5. The battery arrangement according to claim 1, wherein the detection device for detecting the predetermined heating state comprises at least one temperature sensor and/or a pressure sensor and/or a gas sensor and/or a fracture sensor.

6. The battery arrangement according to claim 1, wherein the battery housing has an extinguishing agent outlet element for discharging the extinguishing agent from the battery housing.

7. The battery arrangement according to claim 1, wherein the charging device comprises an extinguishing agent discharge unit which is designed to discharge the supplied extinguishing agent from the battery housing to the waste water reservoir when connected to a motor vehicle-external waste water reservoir.

8. A method for fighting a battery fire of a battery arrangement for a motor vehicle, wherein
the battery arrangement comprises a battery having at least one battery cell, which is arranged in a battery housing, wherein
a charging device of the battery arrangement is connected to a motor vehicle-external energy supply system to provide electrical energy to the at least one battery cell, and
a detection device of the battery arrangement is used to check whether a predetermined heating state is present for the battery, which indicates that a battery fire is present or at least imminent,
characterized in that
the charging device comprises an extinguishing agent supply unit, and by means of the extinguishing agent supply unit, when connected to a motor vehicle-external extinguishing agent reservoir and when the predetermined heating state is present, a predetermined extinguishing agent for supply into the battery housing is provided.

9. A motor vehicle having a battery arrangement according to claim 1.

10. A motor vehicle according to claim 9 wherein the charging device comprises a locking element having a locking mechanism for allowing and/or preventing access to the charging device, wherein the locking element is designed as a charging connection flap of the motor vehicle, by which the charging connection of the charging device and the extinguishing agent supply connection of the extinguishing agent supply unit can be covered from the outside.

11. The battery assembly according to claim 2, wherein the charging device comprises a locking element having a locking mechanism for allowing and/or preventing access to the charging device.

12. The battery arrangement according to claim 2, wherein the extinguishing agent supply unit comprises a valve element which is designed to adjust a mass flow of the extinguishing agent provided depending on the detection of the predetermined heating state.

13. The battery arrangement according to claim 3, wherein the extinguishing agent supply unit comprises a valve element which is designed to adjust a mass flow of the extinguishing agent provided depending on the detection of the predetermined heating state.

14. The battery arrangement according to claim 2, wherein the detection device for detecting the predetermined heating state comprises at least one temperature sensor and/or a pressure sensor and/or a gas sensor and/or a fracture sensor.

15. The battery arrangement according to claim 3, wherein the detection device for detecting the predetermined heating state comprises at least one temperature sensor and/or a pressure sensor and/or a gas sensor and/or a fracture sensor.

16. The battery arrangement according to claim 4, wherein the detection device for detecting the predetermined heating state comprises at least one temperature sensor and/or a pressure sensor and/or a gas sensor and/or a fracture sensor.

17. The battery arrangement according to claim 2, wherein the battery housing has an extinguishing agent outlet element for discharging the extinguishing agent from the battery housing.

18. The battery arrangement according to claim 3, wherein the battery housing has an extinguishing agent outlet element for discharging the extinguishing agent from the battery housing.

19. The battery arrangement according to claim 4, wherein the battery housing has an extinguishing agent outlet element for discharging the extinguishing agent from the battery housing.

20. The battery arrangement according to claim 5, wherein the battery housing has an extinguishing agent outlet element for discharging the extinguishing agent from the battery housing.
